(19) United States
(12) Patent Application Publication
(10) Pub. No.: US 2026/0245541 A1
(43) Pub. Date: Aug. 20, 2026

(54) METHOD AND SYSTEM FOR PROVIDING MEAT BASED ON INTEGRATING VOICE CHARACTER

(71) Applicant: THE DELICIOUS HARU CO., LTD., Gyeonggi-do (KR)

(72) Inventor: JIN HO PARK, Gyeonggi-do (KR)

(21) Appl. No.: 19/309,862

(22) Filed: Aug. 26, 2025

(30) Foreign Application Priority Data
Feb. 17, 2025 (KR) 10-2025-0019921

(51) Int. Cl. G10L 13/033; G06Q 10/08; G10L 13/047

(52) U.S. Cl. CPC G10L 13/0335; G06Q 10/08; G10L 13/047

(57) ABSTRACT

A method for managing meat distribution includes receiving conversation data of a conversation partner from a server, generating a conversation message regarding meat distribution with the conversation partner from the server, and converting the generated conversation message into a voice message. The converting into a voice message is characterized in that the conversion is performed based on information of the conversation partner and the content of the conversation message.

### CROSS-REFERENCE TO RELATED APPLICATION AND CLAIM OF PRIORITY

This application claims the benefit under 35 USC §119 of Korean Patent Application No. 10-2025-0019921, filed on February 17, 2025, in the Korean Intellectual Property Office, the entire disclosure of which is incorporated herein by reference for all purposes.

### BACKGROUND

### 1. Technical Field

The present invention relates to a meat distribution method and system using language personality assignment, and more specifically, to a method and system for transmitting meat distribution information converted into a voice and personality type preferred by the conversation partner based on the analyzed data by analyzing the conversation or phone conversation content of a distribution person, and therefor.

### 2. Background Art

Recently, even when selling the same product, the sales are significantly affected by the method of selling it, that is, the level of promotion and marketing.

As it becomes more important who sells the product even when selling under the same sales conditions, the role of the show host in existing home shopping has become more important, and as this role expands to influencers such as YouTubers, who sells the product in various media has an impact on the reliability of the quality of the product being sold.

Therefore, manufacturers who need to sell products place great importance on selecting sellers for successful sales, and among the factors determining sellers, there are various variables inside and outside the seller, such as the seller's external reputation, appearance, and voice.

In the case of face-to-face sales, the appearance of each seller has a significant impact, so the appearance, clothing, and behavior of the seller are thoroughly prepared. However, in the case of non-face-to-face methods such as phone calls, considerable weight is placed on the voice, so many voice actors and celebrities are hired who can accurately convey the message.

However, even if the speaker has the same voice actor or celebrity, he or she can approach consumers with various tones, such as a calm tone or an active tone, depending on what content he or she speaks with and what expressive power he or she has.

For example, in the case of food, a tone of voice is used to provide a familial and harmonious tone, and in the case of travel products, a tone of voice is used to provide a bright and cheerful tone.

The technology of providing users with such tones by giving them to language is widely used in navigation that provides guidance by converting text with the same content into various voice tones (Korean Patent Publication No. 10-2019-0094315, published on August 13, 2019).

Users will receive information in the voice tone of their preferred celebrity or voice actor, and through good delivery, they can improve the conversational focus of the conversation partner and secure high persuasive power.

Therefore, in this disclosure, a method and a system for providing information by analyzing various conversations, messages (text), calls, etc. that occur during the meat distribution process and converting the messages into a preferred voice and personality of the other party in the meat distribution process into a database are disclosed.

### SUMMARY

The present invention is intended to solve the problems of the prior art described above, and can collect conversation data between transaction parties during the meat distribution process, analyze the data, and create a database.

In addition, according to the present invention, the emotion can be determined by analyzing the tone of voice of the conversation speaker.

One embodiment of the present invention relates to a meat distribution management method, including: receiving conversation data from a conversation partner from a server; generating a conversation message regarding meat distribution with the conversation partner from the server; and converting the generated conversation message into a voice message. The step of converting the voice message is characterized by converting the message based on information about the conversation partner and the content of the conversation message.

Furthermore, the step of converting the voice message is characterized by converting the voice message into a voice message of a character with whom the conversation partner has previously conversed.

Preferably, the step of converting the voice message is characterized by reflecting personality type information preset for the character.

Furthermore, the step of generating the conversation message is characterized by learning existing transaction data with the conversation partner and generating a meat purchase inducement message tailored to each conversation partner.

Another embodiment of the present invention relates to a meat distribution management system, comprising: a server; And the server is configured to receive conversation data of the conversation partner, generate a conversation message about meat distribution with the conversation partner, convert the generated conversation message into a voice message, and transmit it to the conversation partner terminal, and is characterized in that the conversion is performed based on the information of the conversation partner and the content of the conversation message.

The present invention is intended to solve the problems of the prior art described above, and can collect conversation data between transaction parties during the meat distribution process, analyze the data, and create a database.

In addition, according to the present invention, the emotion can be determined by analyzing the tone of voice of the conversation speaker.

### BRIEF DESCRIPTION OF THE DRAWINGS

FIG. 1 is a conceptual diagram illustrating a meat distribution management system according to an example of the present invention.

FIG. 2 is a diagram illustrating a meat distribution management process according to an example of the present invention.

FIGS. 3 and 4 are diagrams illustrating a conversation data processing process according to an example of the present invention.

FIG. 5 is a block diagram conceptually illustrating the structure of a server according to an example of the present invention.

### DETAILED DESCRIPTION

Hereinafter, with reference to the attached drawings, embodiments of the present invention are described in detail so that those skilled in the art can easily practice the present invention. However, the present invention may be implemented in various different forms and is not limited to the embodiments described herein. In addition, in the drawings, parts unrelated to the description are omitted to clearly explain the present invention, and similar parts are designated with similar drawing reference numerals throughout the specification.

Throughout the specification, when a part is said to be "connected" to another part, this includes not only the cases where they are "directly connected" but also the cases where they are "electrically connected" with other elements in between. Furthermore, when a part is said to "comprise" a component, this does not mean that the other components are excluded, but rather that the other components can be included, unless otherwise specifically stated.

In the present invention, the term “user device” refers to a device that performs a function performed through one or more applications, and generally provides meaningful information to the user by performing the function within the user device itself or by linking with an external server. For example, the device may be of various forms such as a smartphone, tablet PC, laptop, desktop, Mac, smart watch, smart glasses, smart ring, or smart band.

In the present invention, “meat” means meat that can be consumed by humans, such as beef, pork, and chicken, and can be classified as domestic if raised and slaughtered domestically, and imported if imported from overseas.

For example, in the case of pork, the spine must be attached to the ribs to be considered domestic, and domestic and imported products can be distinguished based on various legal standards.

In the case of domestic products, it is easy to check domestic demand, distribution volume, inventory volume, etc., and it is possible to adjust the slaughter volume by considering these volumes, whereas imported products are mainly long-distance and have a long delivery period, so the risk regarding price and inventory volume is bound to be greater in the case of imported meat.

In the present invention, the term "conversation partner" includes both the seller selling meat to the consumer and the consumer purchasing the meat, and is a person who engages in conversation with the server as the conversation partner. In some cases, the "conversation partner" may include multiple parties. For convenience of explanation, this disclosure will assume a one-on-one conversation.

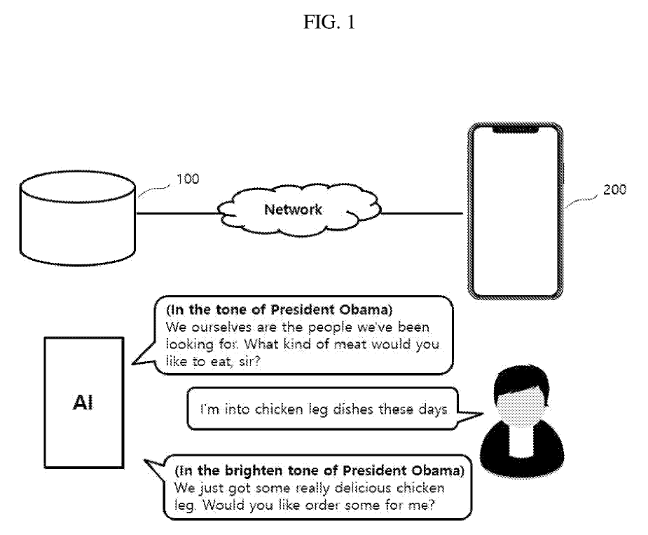

FIG. 1 is a conceptual diagram illustrating a meat distribution management system according to an example of the present invention.

As illustrated in FIG. 1, in a meat distribution management system according to an example of the present invention, a server (100) and a conversation partner device (200) are connected via a network.

A server (100) according to an example of the present invention is an AI bot that converses with a conversation partner device and is a device capable of natural language processing. The server (100) according to an example of the present invention is a device equipped with both a generation technique for generating messages for conversation with a conversation partner and an analysis technique for understanding the message of the conversation partner, and is a device capable of having a conversation appropriate to the situation, rather than simply transmitting a set phrase to the conversation partner.

Since existing technologies related to Natural Language Processing have been developed to a certain level, such as ChatGPT by OpenAI, etc., detailed descriptions of the Natural Language Processing technologies themselves will be omitted in this disclosure, and the focus will be on processing conversation data in the meat distribution process.

The conversation partner device (200) is a device that conducts a conversation with the server (100) and transmits the conversation partner's speech, text, image input, etc. to the server (100). Various devices such as smartphones, tablets, laptops, desktops, and MACs can be included here.

Hereinafter, the operation of a server (100) according to an example of the present invention will be specifically disclosed.

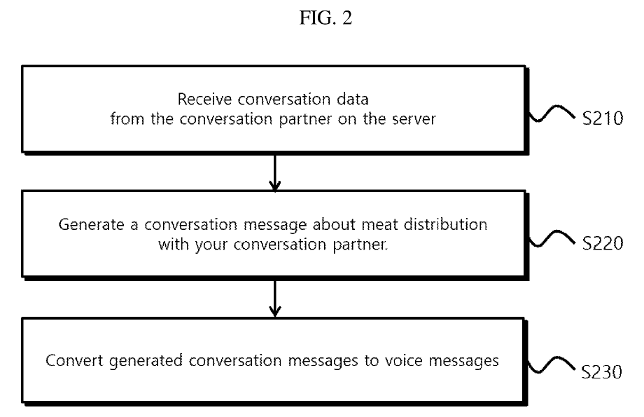

FIG. 2 is a diagram illustrating a meat distribution management process according to an example of the present invention.

As illustrated in FIG. 2, a server according to an example of the present invention receives conversation data of a conversation partner (S210).

A server according to an example of the present invention can initiate a conversation with a conversation partner for the first time. Since no information about the conversation partner is available in the case of an initial conversation, a server according to an example of the present invention can receive information about the conversation partner as conversation data.

For example, basic information such as the gender, age, affiliation, and position of the conversation partner can be collected through other metadata even before conducting the conversation, so it can be received as conversation data.

If there is an existing conversation between a server and a conversation partner according to an example of the present invention, the existing conversation data can be received as conversation data. Conversation data can be broadly categorized into voice, message, video, etc., and through various types of conversation data, the gender, age, etc. of the conversation partner can be determined within a certain range (e.g., male in his 40s to 50s), and if the existing conversation is voice, the conversation partner's information can be specifically identified through voice analysis of the conversation partner's speaking speed, vocal range, intonation, etc.

For example, a server according to an example of the present invention may include a person in his 50s from Gyeongsang Province in a case where a dialect (e.g., ‘Jeongguji’) is included in an existing conversation message and the accent is Gyeongsang Province.

A server according to an example of the present invention can retrieve meat distribution information from existing conversation data. For example, a server according to an example of the present invention can obtain meat distribution information such as past order history information, the type of meat desired to be purchased, the distribution quantity range, and the price range.

According to an example of the present invention, a server generates a conversation message about meat distribution with a conversation partner (S220).

A conversation message according to an example of the present invention refers to the content of a conversation exchanged between a server and a conversation partner, and may be a conversation about meat distribution as content appropriate to the context.

For example, a conversation message according to an example of the present invention is a conversation message that includes all or part of a meat purchase inducing message, price information as meat distribution status information, popular meat information, expected delivery time information, and existing transaction inquiry information.

A conversation message according to an example of the present invention can be regenerated according to a message from a conversation partner, and a series of conversations can be performed as this process is repeated.

A server according to an example of the present invention converts a generated conversation message into a voice message (S230).

A server according to an example of the present invention converts based on the information of the conversation partner and the content of the conversation message.

According to an example of the present invention, a server converts a message into a voice message based on information about the conversation partner, such as the conversation partner's gender, age, affiliation, etc., and, for example, can convert the voice tone of a woman in her 20s from Gyeongsang Province into a voice preferred by a man in his 50s from Gyeongsang Province. In this case, the voice tone of a woman in her 20s from Gyeongsang Province does not simply refer to a frequency band, speaking speed, or use of dialect, but is a tone that is determined probabilistically according to an LLM (Large Language Model).

In addition, a server according to an example of the present invention can convert a voice message into a voice message of a unique character, such as a celebrity, a specific entertainer, or a voice actor.

In the case of celebrities or specific entertainers, they can increase the concentration of the conversation by providing a sense of familiarity to the conversation partner through their experience of being exposed to them a lot, and in the case of voice actor characters, they can also have the advantageous effect of increasing the understanding of the conversation partner through their high level of communication.

In some cases, it may be a voice model of a character that has previously conversed with the conversation partner, or a character that exists in the conversation data of the conversation partner. For example, it may be an AI voice that has successfully facilitated a meat transaction in the conversation partner's previous conversation.

As another example, if the conversation with the conversation partner in the existing conversation data does not consist of meat trading or if the conversation partner identifies words that contain negative feedback (e.g., don't call), it is also possible to convert the voice message into a voice model of a different character from the character in the existing conversation.

A server according to an example of the present invention can also receive character information set through a conversation partner device and convert a voice message into the voice tone of the set character.

According to an example of the present invention, a server can convert a conversation message into a voice message by reflecting the personality type information preset for the character.

In the process of converting a conversation message into a voice message in the present invention, the character of the AI voice is determined, and the voice of the character can be changed according to various personality types.

For example, in addition to the everyday personality, it can be preset for each personality type, such as cheering (bright), comforting (calm), encouraging (strong tone), and surprising (high pitch).

Personality type information according to one embodiment of the present invention may be assigned based on the context of a conversation message. Even when the conversation partner utters a question, if simple information needs to be conveyed, the message should be delivered in a calm tone of voice. However, if the context requires expressing surprise, the message should be delivered in a high pitch and with a different intonation. Therefore, it is important to understand the context of the conversation.

In addition, a server according to an example of the present invention can generate a message that induces the purchase of meat and convert it into a voice message according to the other party's speech in the process of conducting a context-appropriate conversation with the other party in a series of conversation processes.

According to an example of the present invention, a server transmits data converted into a voice message to a conversation partner device, thereby providing the advantageous effect of allowing the conversation partner to have an experience similar to actually talking to a person, rather than an experience of chatting with a server.

In some cases, image analysis techniques may be applied in the form of video calls rather than just using voice messages, and conversations may be conducted in the form of a combination of voice conversation and text chat.

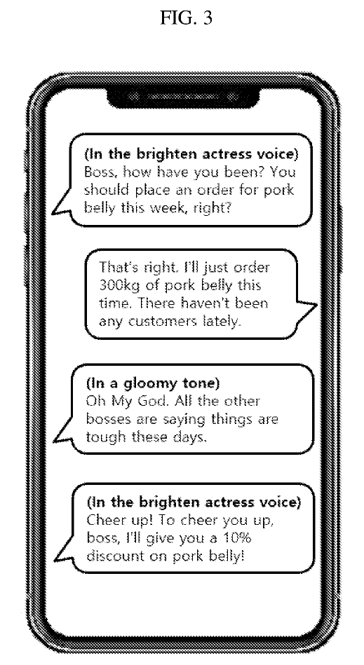

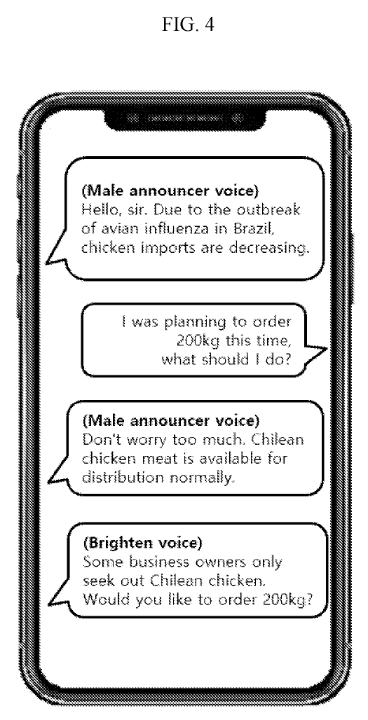

FIGS. 3 and 4 are diagrams illustrating a conversation data processing process according to an example of the present invention.

As illustrated in FIG. 3, a conversation with a counterpart can be conducted through a series of conversation processes according to one embodiment of the present invention. Although FIG. 3 depicts a similarity to text chat, the present invention will be described assuming voice conversion.

The entity initiating the conversation can be either the server or the conversation partner. The server may initiate a conversation with the conversation partner to induce the purchase of meat, and conversely, the conversation partner may initiate a conversation with the server to purchase meat.

In FIG. 3, a bright actress was converted as a character, and an existing conversation was conducted with the character, and the transaction may have been successfully completed.

When a conversation message with a negative meaning, such as “There haven’t been any customers lately” is received in the conversation message, the server according to one embodiment of the present invention may decide to generate a message of consolation (empathy).

A server according to one embodiment of the present invention can generate a message such as “Oh My God” as a message of comfort (empathy), and can convert the generated message into a voice tone (melancholy) different from the voice tone (bright) in an existing conversation and transmit it to the conversation counterpart device.

That is, the server according to one embodiment of the present invention can convert into various voice tones depending on the content of the conversation during a series of conversations.

After the comforting message, you can create a message to encourage the purchase of meat, and then change the tone of voice to a brighter tone to encourage the person you are talking to purchase meat.

Generally, a bright and affectionate tone of voice is preferred, but depending on the characteristics of the conversation partner, a commanding tone or strong tone may be preferred. Therefore, when determining the tone of voice, it can be determined by learning conversation data from previous conversation partners.

As illustrated in FIG. 4, a server according to one embodiment of the present invention can increase the concentration of a conversation by transmitting information that may be of interest to the conversation partner (e.g., Brazilian avian influenza) during the process of initiating a conversation with the conversation partner.

By learning the previous transaction data with the conversation partner, the conversation can be initiated at a time when an order transaction is expected, and this process can also increase the concentration of the conversation.

According to one embodiment of the present invention, a server provides information on meat that a conversation partner is expected to purchase, and simultaneously transmits information on the distribution status of the meat, and rather than simply transmitting information, generates a message that induces purchase and converts it into a voice tone preferred by the conversation partner.

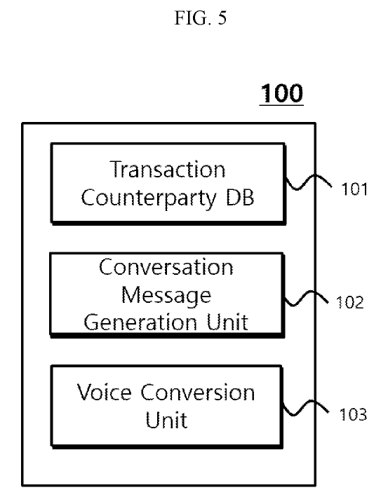

FIG. 5 is a block diagram conceptually illustrating the structure of a server according to an example of the present invention.

As illustrated in FIG. 5, a server (100) according to an example of the present invention includes a Transaction Counterparty DB (101), a Conversation Message Generation Unit (102), and a Voice Conversion Unit (103).

Although not shown in FIG. 5, the server (100) may further include a power supply unit, a storage unit, a communication unit, an input/output unit, a display unit, a sensor unit, and a control unit for smooth operation.

A transaction counterparty DB (101) according to an example of the present invention is a database that accumulates and manages information about a counterparty conversing with a server (100) according to an example of the present invention.

The transaction counterparty DB (101) according to an example of the present invention can collect and manage information on the conversation counterparty, such as gender, age, affiliation, and region.

A transaction counterparty DB (101) according to an example of the present invention can collect and manage information on a conversation counterparty by learning existing conversation data to identify the information on the conversation counterparty or by acquiring it from other types of metadata.

A transaction counterparty DB (101) according to an example of the present invention is a database that accumulates and manages transaction data with a conversation counterparty.

The transaction counterparty DB (101) according to an example of the present invention can store information such as meat, quantity, price, and delivery that the conversation counterparty has ordered in the past.

A conversation message generation unit (102) according to an example of the present invention generates a conversation message regarding meat distribution with a conversation partner based on conversation data received from a transaction partner DB (101).

For example, a dialogue message generation unit (102) according to an example of the present invention can generate a dialogue message including all or part of a meat purchase inducing message, price information as meat distribution status information, popular meat information, expected delivery time information, and existing transaction inquiry information.

A conversation message generation unit (102) according to an example of the present invention can generate a response message according to a message from a conversation partner, and a series of conversations can be performed as this process is repeated.

A voice conversion unit (103) according to an example of the present invention converts a conversation message generated by the conversation message generation unit (102) into a voice message.

A voice conversion unit (103) according to an example of the present invention converts a voice message based on information of the conversation partner and the content of the conversation message, and can convert it into a voice message of a character that previously conversed with the conversation partner.

A voice conversion unit (103) according to an example of the present invention can convert a conversation message into a voice message by reflecting the personality type information preset for the character.

In the process of converting a conversation message into a voice message in the present invention, the character of the AI voice is determined, and the voice of the character can be changed according to various personality types.

For example, in addition to the everyday personality, it can be preset for each personality type, such as cheering (bright), comforting (calm), encouraging (strong tone), and surprising (high pitch).

One embodiment of the present invention may also be implemented in the form of a recording medium containing computer-executable instructions, such as program modules, executed by a computer. Computer-readable media may be any available media that can be accessed by a computer, and includes both volatile and nonvolatile media, removable and non-removable media. Furthermore, computer-readable media may include both computer storage media and communication media. Computer storage media includes both volatile and nonvolatile, removable and non-removable media implemented in any method or technology for storing information, such as computer-readable instructions, data structures, program modules, or other data. Communication media typically includes computer-readable instructions, data structures, program modules, or other data in a modulated data signal, such as a carrier wave, or other transport mechanism, and includes any information delivery media.

While the methods and systems of the present invention have been described with respect to specific embodiments, some or all of their components or operations may be implemented using a computer system having a general-purpose hardware architecture.

The above description of the present invention is provided for illustrative purposes only, and those skilled in the art will readily appreciate that modifications to other specific forms can be made without altering the technical spirit or essential characteristics of the present invention. Therefore, the embodiments described above should be understood as illustrative in all respects and not restrictive. For example, each component described as a single entity may be implemented in a distributed manner, and similarly, components described as distributed may be implemented in a combined manner.

The scope of the present invention is defined by the following claims rather than the detailed description above, and all changes or modifications derived from the meaning and scope of the claims and their equivalents should be construed as being included within the scope of the present invention.

What is claimed is:

1. A method for managing a meat distribution, the method comprising:
receiving conversation data from a conversation partner from a server;
generating a conversation message regarding meat distribution with the conversation partner from the server; and
converting the conversation message into a voice message, based on information about the conversation partner and the content of the conversation message.

2. The method of claim 1, wherein the converting comprises converting the voice message into a voice message of a character with whom the conversation partner previously conversed.

3. The method of claim 2, wherein the converting of the voice message comprises converting the voice message into the voice message of the character with whom the conversation partner previously conversed by reflecting the personality type information preset for the character.

4. The method of claim 1, wherein the generating of the conversation message comprises learning existing transaction data with the conversation partner and generating a meat purchase-inducing message tailored to each conversation partner.

5. A meat distribution managing system comprising,
a conversation partner device; and
a server configured to:
receive conversation data from the conversation partner; and
generate a conversation message regarding meat distribution with the conversation partner;
convert the conversation message into a voice message, based on the conversation partner's information and the content of the conversation message; and
transmit it to the conversation partner device.
